(19) United States
(12) Patent Application Publication
(10) Pub. No.: US 2010/0149149 A1
(43) Pub. Date: Jun. 17, 2010

(54) DISPLAY SYSTEM

(76) Inventor: Joel S. Lawther, Pittsford, NY (US)

Correspondence Address: Pedro P. Hernandez;Patent Legal Staff, Eastman Kodak Company, 343 State Street, Rochester, NY, 14650-2201, US

(21) Appl. No.: 12/334,953

(22) Filed: Dec. 15, 2008

(51) Int. Cl. G09G 5/00

(52) U.S. Cl. 345/211

(57) ABSTRACT

A display system includes a media frame assembly and a removable bezel assembly. The removable bezel assembly includes a power harvesting device for producing energy to drive the media frame assembly. Upon coupling the removable bezel assembly to the media frame assembly.

### FIELD OF THE INVENTION

This invention relates in general to the field of electronics and in particular to a display system.

### BACKGROUND OF THE INVENTION

Digital media frames have become a popular method to display digital images and videos. With the advent of low cost flat panel displays such as LCDs, digital media frames are becoming a preferred method for displaying photographs, resembling the traditional framed photograph on tables and walls of most houses. However, despite more efficient power consuming displays and long life batteries, these batteries have a limited life of just a few hours. Thus, for today's media frames to hang on the wall, a cord must dangle from the frame to a power outlet. This is generally not practical since a cord is perceived as unattractive. Furthermore, these cords can invite kids to pull on them, impacting the safety of the household from small children.

Another solution can be to have an outlet installed behind the media frame on a wall. However, this can require a skilled electrician to make modifications to the wiring system of a home. People that rent their home are generally not granted the right to make these types of modifications to rental property. Another drawback to this approach is that when furniture is rearranged, the pictures on the wall must be moved as well. When a digital media frame is moved, the outlet must be moved to match the location on the wall. As a result, what is needed is a method to provide power to a media frame without a corded power supply.

As a result, there is a need for wirelessly powered media frames that can be adaptable to user needs and yet be flexible to maintain a low cost and to adapt to emerging technologies.

### BRIEF DESCRIPTION OF THE DRAWINGS

The subject matter of the invention is described with reference to the embodiments shown in the drawings.

FIG. 1 is an illustration of a removable bezel assembly and a media frame assembly in accordance with an embodiment of the invention;

FIG. 2 is an inside view of the bezel and media frame assembly in accordance with an embodiment of the invention;

FIG. 3 is an illustration of a bezel assembly, wireless power generator and media frame assembly in accordance with an embodiment of the invention;

FIG. 4 is a block diagram of system components of the invention in accordance with an embodiment of the invention;

FIG. 5 is an illustration of a magnetic system for wireless power transfer in accordance with an embodiment of the invention;

FIG. 6 is an illustration of a direct light powered system for wireless power transfer in accordance with an embodiment of the invention; and

FIG. 7 is an illustration of a radio wave based system for wireless power transfer in accordance with an embodiment of the invention.

### DETAILED DESCRIPTION OF THE INVENTION

The invention has been described in detail with particular reference to certain preferred embodiments thereof, but it will be understood that variations and modifications can be effected within the spirit and scope of the invention.

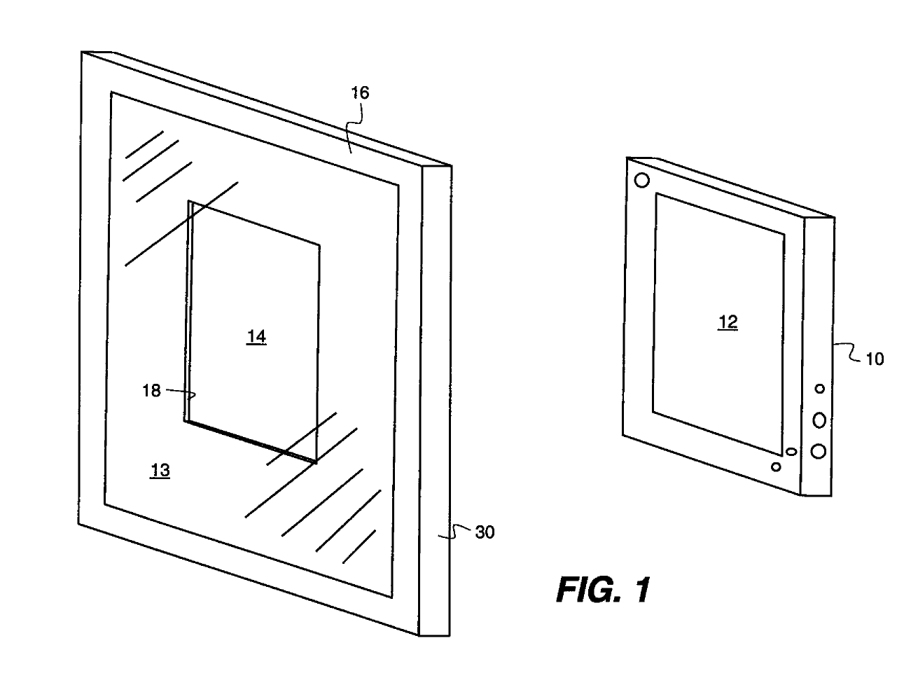

Referring to FIG. 1 there is shown an illustration of a removable bezel assembly 30 and a media frame assembly 10. As shown in FIG. 1, removable bezel assembly 30 generally comprises a framed border 16 and a matte 18 that surrounds aperture 14 that display 12, when assembled, is visible through. Glass cover 13 is an optional method for protecting the matte 18 and display 12 from scratches, dust and dirt. In one embodiment, the matte 18 is designed to be relatively translucent to the power absorbing technology in removable bezel assembly 30. Media frame assembly 10 comprises a display 12 and other components generally found in media frame assemblies 10 as described in commonly-assigned U.S. Pat. No. 7,155,679, issued Dec. 26, 2006 to Eastman Kodak Company and is herein incorporated by reference. In one embodiment, a display system includes a memory, a processing unit, a display, an interface circuit, and a display circuit. The interface circuit has at least one receiving port capable of identifying various types of networking protocols that are used to transfer the image data. The processing unit attaches auxiliary information to each image before images are stored in a memory. The display circuit displays images according to the image data received. The digital media frame further contains a user input device, which allows a user to alter the image display sequence. The user input device is an input device other than a keyboard or a cursor control device.” Display 12, in media frame assembly 10 can be a common liquid crystal display or an alternative technology. Alternative display technologies can reduce power consumption of a media frame assembly 10. These are classified as either Electrophoretic, Electro liquid powder, Electro-wetting, Interferometric-modulation, or Time-multiplexed optical shutters. These display technologies can enable reflective-type bi-stable displays found in e-reader products such as the Amazon Kindle electronic book reader. The Amazon Kindle electronic book reader for example incorporates a display manufactured by Prime View International Corporation (PVI) using laminations manufactured by E-ink Corporation. Additionally, other classes of these low power displays such as Electro-liquid powder are manufactured by Bridgestone Corporation.

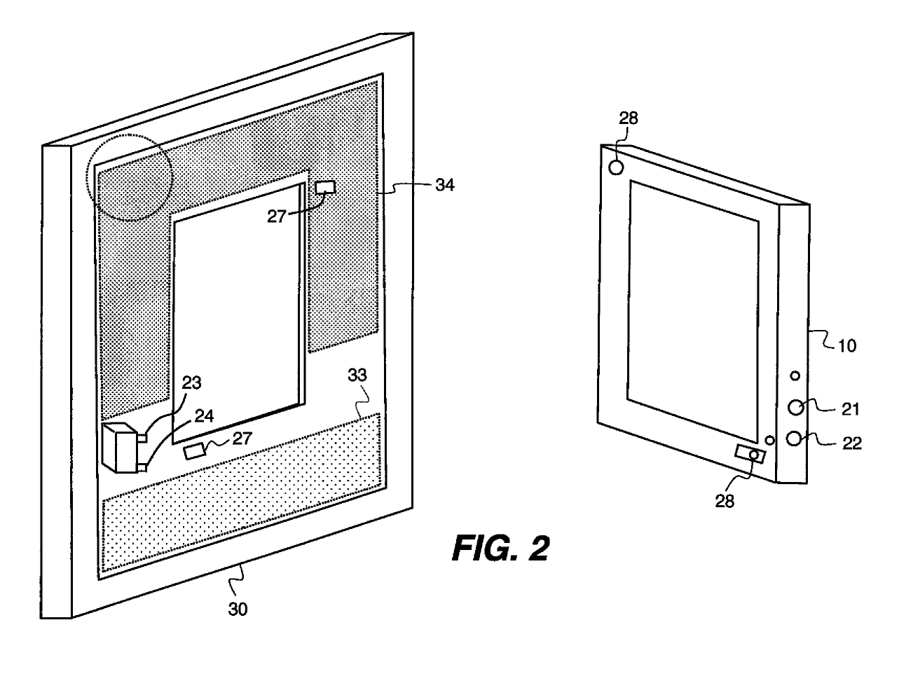

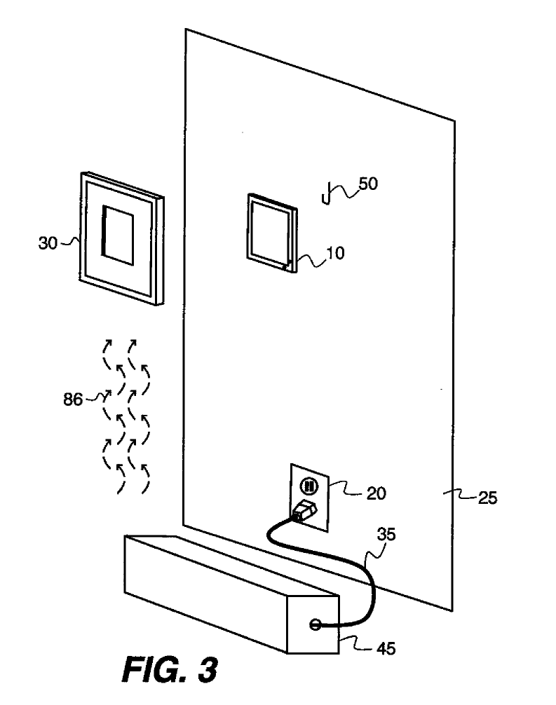

Referring now to FIG. 2, there is shown an inside view of the bezel assembly 30 and media frame assembly 10 in accordance with an embodiment of the invention. Shown are mounting flanges 27 and receivers 28 for alignment and attachment of the removable bezel assembly 30 to media frame assembly 10. Mounting flanges 27 and receivers 28 can be snaps, hole-and-pin press-fit interfaces, magnetic interfaces, Velcro or a combination thereof. Also shown is power supply connectors 23 and 24 from the attachable bezel assembly 30 that electrically connect to provide power to power connectors 21 and 22 of the media frame assembly 10 and help power the media frame assembly 10. In one embodiment of the invention, within the attachable bezel assembly 30 is power absorption photovoltaic array 33. Photovoltaic array 33 harvests power by receiving room light through optional protective glass 13 and matte assembly 18. Additionally, matte assembly 18 can be the photovoltaic array 33 adapted to resemble an artistic matte. Furthermore, optional protective glass 13 can also incorporate photovoltaic array 33. Attachable bezel assembly 30 and matte assembly 18 incorporating photovoltaic array 33 can be available to customers in a range of sizes that produces a range of power harvesting capabilities available to the customer for any single size aperture 14 that is adapted to the size of the display 12. A further benefit of a large matte assembly 18 compared to a smaller sized display 12 is a pleasing artistic effect. This artistic effect can produce a matte assembly 18 area which results in accompanying power harvesting area that can range from one to ten times the area of the display 12. Sunlight flowing through the front of protective glass 13 can strike the photovoltaic array 33 and the energy generated there from can be used to power the display system. FIG. 3 is an illustration of a bezel assembly 30, wireless power generator 45 and media frame assembly 10.

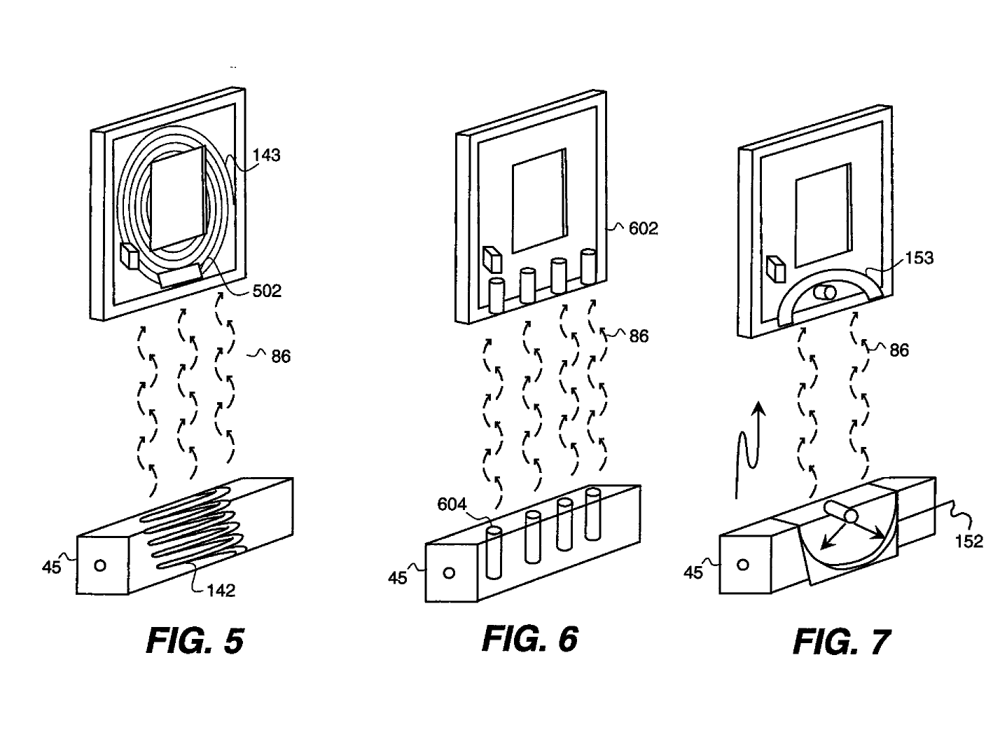

In the embodiment of FIG. 3, bezel assembly 30 and wireless power generator 45 combine to produce a matched system for providing power to media frame assembly 10. Wireless power generator 45 receives common AC outlet power 20 via cord 35. Wireless power generator 45 then converts AC power into wave energy flux 86. Wave energy flux 86 can be a light field generated by bulbs, lasers, LEDs or any light source/transmitter 604 that can be harvested by removable bezel assembly 30 using light receiver section 602 as shown in FIG. 6. Wave energy flux 86 can also be radio waves generated by a radio transmitter 152 and converted into usable energy by radio receiver 153 as shown in FIG. 7. Wave energy flux 86 can also be magnetic waves that are transmitted using coils 142 with an induced electric current and received by receiver 502 shown in FIG. 5 which converts the magnetic waves into electric current to power the media frame assembly 10.

Referring back to FIG. 3, hook 50 holds media frame assembly 10 and attachable bezel assembly 30 to wall 25. Attachable bezel assembly 30 harvests wireless wave energy flux 86 generated by wireless power generator 45. This illustrates the benefit of the absence of a wired connection between the media frame assembly 10 and AC power outlet 20.

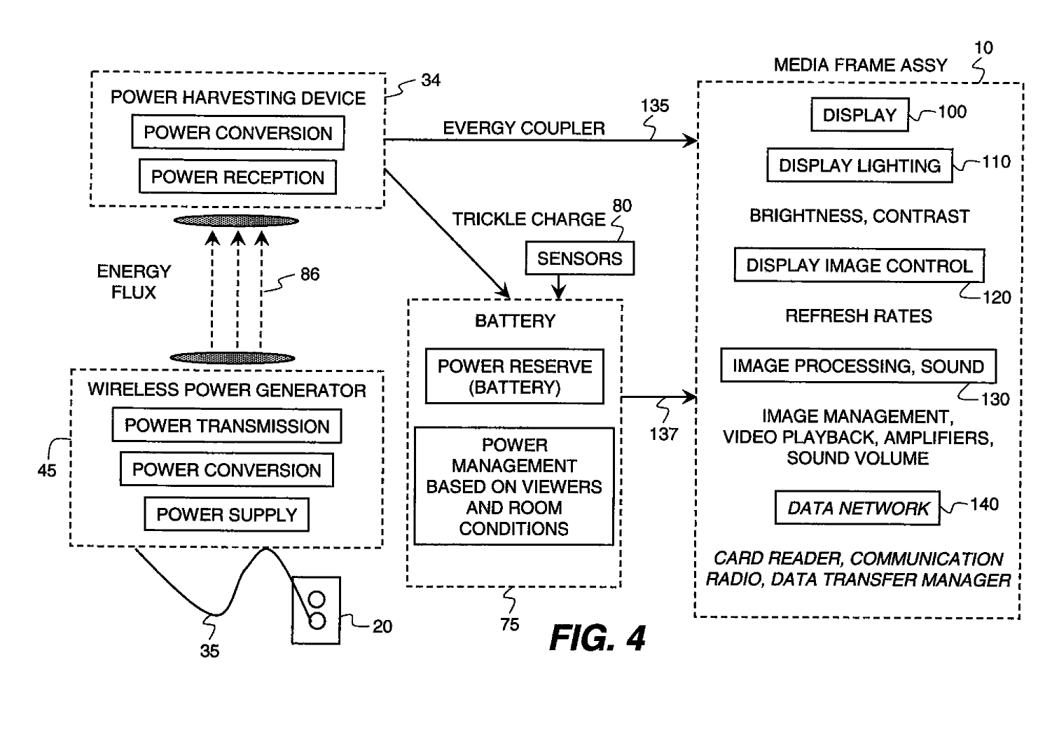

FIG. 4 is a block diagram of system components of the invention. In FIG. 4, wireless power generator 45 receives power from AC power outlet 20 and converts it to energy flux 86 using power supply, power conversion and power transmission circuits in accordance with an embodiment of the invention. Within the attachable bezel assembly 30, power harvesting device 34 receives power provided in energy flux 86 with power reception and power conversion electronics. Power harvesting device 34 provides direct power to media frame assembly 10 through energy coupler 135 using power connectors 21, 22, 23, 24 shown in FIG. 2. Power harvesting device 34 can be internally embedded within the frame assembly in one embodiment.

In another embodiment, power harvesting device 34 provides power to battery 75 that can reside within the attachable bezel assembly 30- Thus, battery 75 provides power to media frame assembly through a battery power energy coupler 137. This embodiment is useful for situations where the power harvesting device is not converting energy all the time, for example when using a photovoltaic array as the power harvesting device when there is no light source available. In yet another embodiment, battery 75 can reside within media frame assembly 10. In embodiments where power transfer is very low and media frame assembly 10 contains a display 12 that is bi-stable, media frame processor 130 can change the image shown on display 12 when there is enough power in battery 75 to drive the media frame processor 130 and change the image shown on display 12. Media frame processor 130 can be one of a number of processors or microcontrollers available in the marketplace and include onboard volatile and nonvolatile memory and a sound generator to play music, etc. Moreover in FIG. 4, media frame assembly 10 contains sensors 80 that can provide input to media frame processor 130 to enable function while a room contains motion, sound volume above a threshold, or detection of faces. Media frame assembly 10 further comprises display lighting 110, display image control 120, media frame processor 130 comprising sound and data network 140. Each of these items in media frame assembly can have varying functional capability at optimum levels based on energy transfer amounts using energy coupler 135. Further, this can also function based on energy transfer using battery power energy coupler 137.

FIG. 5 is an embodiment of an attachable bezel assembly 30 and wireless power generator 45 applying current through coils 142 and inducing current in coils 143 using power harvesting technologies associated with induced magnetic fields providing wave energy flux 86, also known as inductive coupling. An example of this technology is disclosed in U.S. Publication No. 2007/0222426, published Sep. 27, 2007 to Koninklijke Philips Electronics. Disclosed is a wireless resonant powering device that comprises a first inductor winding, which is arranged to form a transformer with the inductor winding of an energizable load. The first inductor winding is arranged to form a resonant circuit, which may comprise a suitable plurality of electric capacitances and coils. The components of the resonant circuit are selected such that the magnetic energy received by the inductor winding damps the energy flow in the resonant circuit so that the induced voltage in the inductor winding is substantially constant and is independent of the magnetic coupling between the first inductor winding and the inductor winding at the operating frequency of the driving means. The resonant circuit is driven by the driving means, comprising a control unit arranged to induce an alternating voltage between a first semiconductor switch and a second semiconductor switch. At the output of the transformer an alternating voltage is generated, which is rectified to a DC-voltage by a diode rectifier, filtered by an output capacitance. The resonant circuit is operable on its coupling independent point by the driving means. Thus, a variable coupling between the first inductor winding and the inductor winding exists. The invention further relates to a wireless inductive powering device, an energizable load, a wireless system and a method for wireless power transfer.

FIG. 6 is an embodiment of attachable bezel assembly 30 and wireless power generator 45 using power harvesting technologies and an energy flux 86 with collimated or near collimated light of various frequencies and density emitting from wireless power generator 45. U.S. Publication 2007/0019693, published Jan. 25, 2007 is one example of this method. Disclosed in this publication is a method and apparatus for wireless power beaming consisting of a transmitter assembly, free space, and an optical-to-electric assembly. The transmitter assembly 604 has eye-safe lasers that create a beam of light. The beam of light goes through free space and impinges upon the surface of optical-to-electric assembly 602. Optical-to-electric assembly 602 has power conversion photodiode(s) to convert the energy in the light into electricity. Power Accounting accounts for the power in the beam and controls the lasers to turn them off whenever radiation is not accounted for in the system.

FIG. 7 is an embodiment of wireless power generator 45 wherein the energy flux 86 is in the form of radio waves. One example is US Publication No. 2007/0298846, published Dec. 27, 2007 to Powercast, LLC. Disclosed is a system for transmission which includes a receiver having a receiver antenna. An RF power transmitter 152 includes a transmitter antenna. The RF power transmitter transmits RF power. The RF power includes multiple polarization components. The receiver 153 converts the RF power to direct current. Also disclosed is an antenna for an RF power transmission system. The antenna includes at least two antenna elements. Alternating the radiation between the at least two antenna elements produces a power transmission having components in two polarizations. Additionally disclosed is a transmitter, a receiver and a method for power transmission. Wireless power generator 45 contains a sending antenna 152 and attachable bezel assembly 30 contains a receiver antenna 153.

By providing a removable bezel assembly 30 that can include therein one of a number of power harvesting receivers, albeit using solar, magnetic, radio frequency or other type of energy source, and which would in turn power the media frame assembly 10 would allow for a display system which can be tailored specifically to a specific user. For example, a display system which will receive a lot of sunlight can use a removable bezel assembly 30 that includes a photovoltaic array 33 having a photovoltaic array having a size tailored to the use conditions (e.g., a room that receives a lot of sunlight can use a removable bezel assembly 30 having a small photovoltaic array 33 as compared to a location that receives less sunlight and which would use a removable bezel assembly 30 having a larger photovoltaic array 33). While a display system that is in a dark room can use a removable bezel assembly 30 that generates electrical current using one of the methods described in association with FIGS. 5-7, etc.

### Parts List

10 media frame assembly
12 display
13 Glass cover
14 hole
16 framed border
18 matte
20 AC outlet power
27 mounting flanges
28 receivers
21 power supply connectors
22 power supply connectors
23 power connectors
24 power connectors
25 wall
30 removable bezel assembly
33 photovoltaic array
34 power harvesting device
35 cord
45 wireless power generator
50 hook
75 battery
86 wave energy flux
110 display lighting
120 display image control
130 media frame processor
135 energy coupler
137 battery power energy coupler
140 sound and data network
142 coils
143 coils
152 RF transmitter
153 RF receiver
502 Magnetic receiver
602 Light receiver
604 Light transmitter

1. A display system, comprising:
a display; and
a bezel attachable to the display, the bezel including a power harvesting device for producing energy to drive the display, the bezel including a connector for coupling the energy from the power harvesting device to the display upon the bezel being attached to the display.

2. A display system as defined in claim 1, wherein the power harvesting device comprises a photovoltaic cell.

3. A display system as defined in claim 1, wherein the power harvesting device comprises a device that receives magnetic waves and converts them into energy for powering the display.

4. A display system as defined in claim 1, wherein the power harvesting device is embedded within the bezel.

5. A display system as defined in claim 1, further comprising an energy storage device for storing energy produced by the power harvesting device.

6. A display system as defined in claim 1 wherein the power harvesting device comprises a wireless device that receives radio frequency waves and converts them into energy for powering the display.
